(19) United States
(12) Patent Application Publication
(10) Pub. No.: US 2019/0070983 A1
(43) Pub. Date: Mar. 7, 2019

(54) APPARATUS FOR ADAPTING A SEATBELT TO A CHILD

(71) Applicant: CARFOLDIO LTD., Raanana (IL)

(72) Inventors: Jon SUMROY, Raanana (IL); Derrick John Martin BARKER, Bishampton, Worcestershire, ENG (GB); Christopher Edward LESTER, Worcester, Worcestershire, ENG (GB); Nicolas Jean Louis PASQUIER, Doue la Fontaine (FR)

(73) Assignee: CARFOLDIO LTD., Raanana (IL)

(21) Appl. No.: 15/518,147

(22) PCT Filed: Mar. 19, 2017
(86) PCT No.: PCT/IL2017/050343

§ 371 Date: Apr. 10, 2017

(51) Int. Cl. B60N 2/28; B60R 22/02

(52) U.S. Cl. CPC B60N 2/2803; B60R 22/26; B60R 22/024

(57) ABSTRACT

An apparatus for adapting an adult three-point seatbelt of a vehicle for safe and secure usage by an occupant such as a child, the seatbelt being of the ubiquitous type that comprises a tensioned belt wound on a drum that extends from above shoulder height of an adult occupant of a seat, to an anchor point connected to chassis of vehicle, and a clasp attached to the chassis on an opposite side of an occupant of the seat from the anchor point, such that the belt may be drawn downwards and across an occupant to engage the clasp, thereby restraining the occupant with both a sash section and a lap section of the seatbelt.

The apparatus comprises a guide for the sash section of the seat belt that is fixed to a seat and sideways adjustable with respect to the occupant sitting on the seat, the sash guide for engaging the sash section above a shoulder of the occupant at a sideways position to ensure that said sash section runs over shoulder of the occupant in an optimal position for both comfort and safety. Different embodiments are directed to a guide attached to the seat of the vehicle itself, retrofittable to a head rest and attached to various child seats such as booster seats that themselves sit on the vehicle seat.

### BACKGROUND

Seat belts, also known as safety belts, are safety devices designed to secure and restrain the occupant of a vehicle, preventing harmful movement during a collision or a sudden stop. The seat belt reduces the likelihood of death or serious injury in traffic collisions by (a) reducing the force of secondary impacts between the occupant and interior surfaces of the vehicle, (b) preventing the occupant being ejected from the vehicle in a crash, and (c) keeping the occupant correctly positioned for maximum effectiveness of airbags where provided.

Seat belts come in various types, including lap restraints or lap belts, sash belts, combination lap and sash belts and three point seatbelts that combine the lap belt and the sash belt into a unitary device.

Lap belts fasten across the lap of the occupant. These were the earliest type of seat belt, and are still the standard restraining means used in the passenger seats of airplanes. The full force of an impact is absorbed along a relatively small area across the waist of the occupant and may cause damage to internal organs. A ‘sash belt’ or shoulder harness is a strap that goes diagonally over the vehicle occupant's outboard shoulder and is buckled inboard of his or her lap. The sash belt restrains the occupant over a larger part of the body than does the lap belt. In combination type restraints, the sash belt may attach to the tongue of the lap belt, or it may have a tongue and buckle completely separate from those of the lap belt.

The 3-point belt is similar to the combination of separate lap and sash belts, but is provided as a single unit. Like the separate lap-and-sash belt, in a collision the 3-point belt spreads out the energy of the moving body over the chest, pelvis, and shoulders.

The three point seat belt is now standard in most road vehicles, It comprises a tough strip of fabric, typically woven nylon, which is fastened to the car below the height of the seat on one side of the passenger, and is wound onto a spring loaded reel or drum that is above shoulder height or at least is threaded over a pulley that is above shoulder height and then drawn down to a drum or reel that takes up spare seatbelt. Typically, a buckle that is coupled to the seatbelt is pulled down, across the passenger, from the shoulder to the other side of the passenger near the passenger's waist, where it engages a clasp provided for that purpose. In most designs, pressure on a release lever on the clasp releases the buckle, and the drum winds the belt up. In some models, the seatbelt itself is pulled down and across the occupant and is shackled by a releasable rod or loop.

Such three point seatbelts restrain the seated passenger with a strap that crosses the thighs from where a fixed end of the seatbelt is fastened to the chassis on one side, through an eye of a slider that is provided with a buckle that is slid into and held by the clasp, and then up across the body and over the shoulder to the reel or pulley wheel. The section of the strap that runs from the fixed end to the eye of the slider is known as the lap section or the lap belt section, and the section that runs from the slider to the reel is known as the sash section or sash belt section.

On impact or sudden stopping, the reel jams and prevents the seatbelt from being pulled out further, and typically is configured to retract the seatbelt. Such seat belts are reliable, convenient, and easily implemented to restrain the passenger, and easily released to allow the passenger to exit the vehicle.

Seatbelts are mandated by law in many countries, for both front-seat and back-seat passengers of many vehicles. In some jurisdictions passengers in public transport vehicles, such as taxicabs and the like, are not required to wear seatbelts, but the safety advantages of so doing are nevertheless clear.

Until the 1980s, three point seatbelts were commonly available only in the front outboard seats of cars, while the back seats were often only fitted with lap belts. Evidence of the potential of lap belts to cause separation of the lumbar vertebrae and the sometimes associated paralysis, or “seat belt syndrome”, led to progressive revision of passenger safety regulations in nearly all developed countries to require three-point belts in all outboard seating positions, and eventually in all seating positions in passenger vehicles.

Most modern seat belts are stowed on spring-loaded reels called ‘retractors’ which are equipped with inertial locking mechanisms that stop the belt from extending off the reel during severe deceleration. Seatbelts in many newer vehicles are also equipped with ‘pretensioners’ and/or ‘Webclamps’. Pretensioners preemptively tighten the belt to prevent the occupant from jerking forward in a crash. Some systems also pre-emptively tighten the belt in fast accelerations and strong decelerations even if no crash has happened. Webclamps clamp the webbing in the event of an accident and limit the distance the webbing can spool out (caused by the unused webbing tightening on the central drum of the mechanism). These belts also often incorporate an energy management loop (“rip stitching”) in which the lower part of the webbing is looped and stitched with a special stitching designed to “rip” at a predetermined load, which reduces the load transmitted through the belt to the occupant, thereby reducing injuries to the occupant.

As with adult drivers and passengers, the advent of seat belts was accompanied by calls for their use by child occupants, including legislation requiring such use. Generally children using adult seat belts suffer significantly lower injury risk when compared to non-buckled children. It will be appreciated that three point seatbelts are standard fixtures that are appropriate for restraining adults of various shapes and sizes. They are, however, engineered for adults, and are thus typically too big for small children. Adult three-point seatbelts are generally inappropriate for children since the lower strap crosses the stomach and is consequently uncomfortable and potentially dangerous, and the diagonal shoulder strap invariably misses the shoulder of a child, and interferes with his or her neck or head. However, if the seatbelt is positioned under the arm, the seatbelt rubs against the underarm and/or neck, and is uncomfortable. Positioning the seatbelt under the arm is also dangerous, in that both sections of the belt cross the lower abdomen, and an impact may cause the seatbelt to retract across the stomach, risking rupturing internal organs.

Many jurisdictions now advocate or require child passengers to use specially designed child restraints such as separate child-sized seats equipped with their own restraints and booster cushions or seats for use by children together with the adult restraints. In some jurisdictions children below a certain size are forbidden to travel in front car seats.

Child safety seats (sometimes referred to as an infant safety seat, a child restraint system, a restraint car seat, or ambiguously as car seats) are seats designed specifically to protect children from injury or death during collisions. Automobile manufacturers may integrate child safety seats directly into their vehicle's design. Most commonly, child safety seats are purchased and installed by consumers. Many regions require children of certain ages, weights, and/or heights to use a government-approved child safety seat when riding in a vehicle. Child safety seats provide passive restraints and must be properly used to be effective. However, many child safety restraints in countries such as Canada and the United States are not used properly. To tackle this negative trend, health officials and child safety experts produce child safety videos to teach proper car seat installation to parents and caregivers. Baby car seats are legally required in many countries, including the United States, to safely transport children up to the age of 2 or more years in cars and other vehicles.

Booster seats are recommended for use by children that are too big for harnessed toddler seats, until they are big enough to properly use a seat belt without them. Traditional booster seats raise the child and allow the seat belt to sit firmly across the collar bone and chest, with the lap portion fitted to the hips. If the seat belt is not correctly positioned across the collar bone and the hips, it will generally ride across the neck and the stomach and cause internal injuries in the event of a collision. Traditional booster seats also facilitate the child looking out of the window, and, since the child is more comfortable and has better vision, are generally accepted by children. Some jurisdictions require booster seats to be used by law. For example, booster seats are required by law in the US, up to the age of 9 or a weight of 90 pounds (41 Kg).

It will be appreciated that traditional booster seats are large and bulky devices. Where a back seat of a vehicle is sometimes used to transport adult passengers and sometimes for transporting children, the booster seat has to be removed and replaced. Traditional booster seats take up a lot of space and their storage in the trunk of a vehicle, minimizes the amount of groceries and other goods being transported. They are an additional expense for grandparents and other occasional drivers of children. When renting cars, such as for family holidays abroad, booster seats may need to be rented separately. This is an additional expense that may tempt parents to economize. For these and similar reasons, booster seats are often not available when required.

Shorter adults that are not appropriately secured by the car seatbelts may feel uncomfortable sitting on a booster seat, as may shorter children being transported to social events attended by taller peers.

U.S. Pat. No. 3,136,579 to Hunter, is an early example of a booster seat that raise the child to allow him or her to look out of the windows, but is bulky and cumbersome.

U.S. Pat. No. 3,380,775 to Offenbacher describes another bulky booster seat solution.

U.S. Pat. No. 3,265,438 to Regan et al. describes a pneumatically inflatable seat that can be deflated for storage. Pneumatic solutions are complicated and unreliable, and this never really caught on.

U.S. Pat. No. 3,547,489 to Grieser and U.S. Pat. No. 4,231,613 to Jonasson describe booster seats that have side loops for engaging a seat belt. The devices are fairly bulky. They are designed for the more or less obsolete lap straps, but are not suitable for use with three-point seatbelts.

U.S. Pat. No. 4,291,915 to Cox describes a booster seat that doubles up as a suitcase and can be used for storing objects therein, going someway to overcome the inherent space requiring disadvantage of booster seats. However, the device described is somewhat complicated and therefore expensive to manufacture, and it is not really a practical storage solution for more than its straps.

U.S. Pat. No. 4,461,510 to Cunningham, titled “Childs safety device for vehicle” describes a booster seat with a strap that goes behind the child and engages the shoulder strap of a three point seat belt. The strap may be adjusted in effective length for different sized children, but the width of the seat is fixed, and the leg straps may not be comfortable for children that are significantly narrower than the booster seat. Additionally, Cunningham's booster seat is fairly cumbersome.

U.S. Pat. No. 5,308,116 to Zawisa describes a device that engages the shoulder strap of a three point seatbelt at an adjustable height suitable for smaller passengers. However, the system described therein is only suitable for outside seated passengers, whereas the middle seat is generally considered the safest position for backseat passengers. Furthermore, although offering a solution for larger children, the lap engaging section of the strap will generally be too high for smaller passengers that are, nevertheless, too large for an infant seat.

U.S. Pat. No. 5,468,020 to Scime describes an auxiliary harness that engages the seatbelt and adapts it to the child. Scime's system is different from the typical booster that raises the child, but is nevertheless, fairly bulky and thus inconvenient.

U.S. Pat. No. 5,609,367 to Eusebi et al, describes an adjustable three point restraint system that is suitable for both children and adults. It is part of the vehicle and significantly increases manufacturing costs of the vehicle. It is not retrofittable to standard vehicles provided with conventional three point seatbelts.

U.S. Pat. No. 5,733,004 to Krevh describes a fairly simple compact device for adjusting the shoulder strap of a three-point seatbelt and making it appropriate for use by a child. The device is designed for use with a booster seat. The device described is fairly compact, but when used with a booster seat, the space required for the booster seat makes the solution bulky and cumbersome and inappropriate for occasional use.

U.S. Pat. No. 5,797,654 to Stroud describes a belt buckle/tether strap for use with a booster seat that combines the advantages and disadvantages of U.S. Pat. No. 4,461,510 to Cunningham and U.S. Pat. No. 5,733,004 to Krevh.

U.S. Pat. No. 5,845,967 to Kane and U.S. Pat. No. 7,066,536 to Williams describe other bulky booster seats and children's seat designs.

WO9700184 to Smith describes a safety belt restraint device that holds the lap belt down and has a flatter profile than the conventional booster seat. Two embodiments are described. The first one holds the belt down between the legs and over each leg separately. The second is a sort of tray that engages the seatbelt. Whilst perhaps appropriate for a child whose width is not much narrower than the tray, the pelvis of a smaller child will not be adequately protected.

U.S. Pat. No. 7,703,806 to Bell et al. entitled “Seat Belt System for a Motor Vehicle” describes a system for adjusting the shoulder strap to the height of the passenger. However, since the lap strap remains configured to the width of an adult, it may be inappropriate for use by smaller children as it risks damage to a narrow pelvis in impact.

USSN 2012/0019033 to Kelly describes an inflatable booster. By deflating the device, it may be stowed without significantly filling storage resources needed for luggage, groceries and the like. However, as described hereinabove with reference to U.S. Pat. No. 3,265,438 to Regan et al., the inflatable system is not really practical for occasional use, such as by grandparents and the like. Some adults are fastidious about using the mouth nozzle to inflate a booster seat, not knowing who previous users were. Inflatable seats may take two or three minutes to inflate, and require good lungs, and are thus problematic for many people such as asthmatics, the elderly and heavy smokers, for example. Additionally, the deflated seat itself takes up space.

CZ 2007,466 describes yet another booster seat.

U.S. Pat. No. 6,846,020 to Zhaoxia Xu describes a seat belt restraint system for a vehicle occupant seated in a vehicle seat, more specifically for both an adult and a child or a person of small stature. The seat belt restraint system includes a conventional three-point seat belt restraint system for an occupant of normal size and an adjusting mechanism adapted to provide additional fixation points on the seat belt webbing, more specifically on the shoulder belt, and adapted to adjust the departure angle at which shoulder belt extends across the body of a child or a person of small stature. The approach taken provides a plurality of fixation points on the back of the car seat, to adjust the effective vertical anchorage. The solution thus adjusts the angle of the seatbelt.

U.S. Pat. No. 9,376,088 to Sumroy describes a radical departure to the traditional booster seats. Instead of raising the child into the adult harness, with the various disadvantages documented above, Sumroy describes a mat that has width-wise adjustable clips for holding the lap section of a three point seatbelt close to the hips of the child, a strap that is attached to the mat and a clip for engaging the sash part of the seat belt and for holding it an appropriate height over the shoulder of the child.

Since the occupant sits at the height of the car seat, children and indeed shorter adults do not feel that Sumroy's solution is childish.

A preferred embodiment of Sumroy's solution is shown in FIGS. 10-15 of pending application US 2016/264,025 that is also protected by various design registrations and is sold as a Mifold™ grab and go seat, which has won international acclaim.

Despite the various attractive features of the conceptual arrangement shown in U.S. Pat. No. 9,376,088 and the preferred embodiment shown in the continuation published in pending application US 2016/26,4025, it will be noted that Sumroy's published solution does not provide head support, which is generally desirable and may be required by legislation. Currently available traditional booster seats that do provide head support, do not engage the seatbelt in an optimum manner.

There remains a need for a compact alternative to traditional booster seats for adapting a three point adult seat belt for use by smaller passengers that engages the seatbelt in an optimum manner. There is a particular need for alternatives that provide head support.

### BRIEF SUMMARY

A first aspect is directed to an apparatus for adapting to an occupant, an adult three-point seatbelt of a vehicle having a chassis, the adult three-point comprising a belt that extends from an upper point proximal to a shoulder of an adult occupant of a seat, to a lower anchor point connected to the chassis below the upper point, and a tongue on a slider attached to said strap, for dividing said strap into a sash section and a lap section, and a buckle attached to the chassis on an opposite side of the occupant of the seat from the lower anchor point, such that the belt may be drawn downwards and diagonally across an occupant to for the tongue to engage the buckle, thereby restraining the occupant with both a diagonal sash section and a lap section of the seatbelt; the apparatus comprising a guide for the sash section of the seat belt that is fixed to a seat and sideways adjustable with respect to the occupant sitting on said seat, said guide for engaging said sash session above a shoulder of said occupant at a sideways position to ensure that said sash section runs over a shoulder of the occupant in an optimal position for both comfort and safety.

Typically, the adult three-point is selected, from the group of a tensioned belt wound on a drum and a 3 point static seat belt.

In some embodiments, the seat is a built-in vehicle seat and said guide is coupled to back of said built-in vehicle seat.

In some embodiments, the seat is a built-in car seat and said guide is coupled to a headrest of said built-in vehicle seat.

In some embodiments, the guide is retrofittable to said vehicle seat.

In some embodiments, the seat is a booster seat and said guide is adjustably coupled to said booster seat.

In some embodiments, the seat is a booster seat with a headrest and said guide is adjustably coupled to said head rest.

In some embodiments, the seat is a collapsible child's seat that is positioned on integral vehicle seat under the occupant, and having a guide for engaging the sash strap of the vehicle that is sideways positionable with respect to shoulder of an occupant sitting on said apparatus.

Optionally, the apparatus comprises a seat section, a headrest coupled to the seat section by an adjustable strut, wherein the guide for engaging the strut is sideways adjustably coupled to the head rest.

Optionally, the strut is telescopic.

In some embodiments, the strut folds with respect to the said section.

In some embodiments, the strut folds with respect to the headrest.

In some embodiments, the sash strap guide is automatically positioned appropriate to an occupant by positioning the head rest appropriately for said occupant.

In some embodiments, the sash strap guide is forwards-backwards and/or up-down adjustable as well as sideways adjustable.

A second aspect is directed to a method of adjusting an three point seatbelt comprising a sash section and, a lap section, to safely and, comfortably engage an occupant sitting in a vehicle, the method comprising providing a sash strap guide that is sideways adjustable for engaging the sash section of the three point seatbelt at a point proximal to the shoulder of the occupant, that is sideways adjustable to optimally position the seatbelt for comfort and safety.

Optionally, the sash strap guide is attached to a booster seat that engages the lap section over the occupant's legs.

Optionally, the method comprises providing a collapsible seat comprising a seat section; a headrest; a widthwise adjustable lap strap engaging means for engaging the lap section of a three point seatbelt against the legs of the occupant; the sash strap guide being adjustably coupled to the headrest for adjustingly engaging the position of the sash strap to correct align the sash strap with the shoulder of the child for optimum comfort and safety.

Optionally, the sash strap guide is automatically positioned as collapsible seat is opened out and adjusted to the occupant.

Optionally, the sash strap guide is forwards-backwards and/or up-down adjustable in addition to sideways adjustable for optimum positioning with respect to the occupant.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention; the description taken with the drawings making apparent to those skilled in the art how the several forms of the invention may be embodied in practice.

In the accompanying drawings:

FIG. 1a is a schematic illustration of a prior art seatbelt arrangement designed for adults;

FIG. 1b is a schematic illustration of an adult occupant restrained by the prior art seatbelt arrangement of FIG. 1a, showing the sash section of the belt correctly positioned on the adult's neck;

FIG. 1c is a schematic illustration of a child occupant restrained by the prior art seatbelt arrangement designed for adults of FIGS. 1a and 1b, showing the sash section of the belt uncomfortably positioned against the child's neck;

FIG. 1d is a schematic illustration of the child occupant restrained by the prior art seatbelt arrangement designed for adults, where the child occupant has avoided the uncomfortable rubbing of the belt against her neck by positioning the sash section of the seat belt under her arm;

FIG. 2a shows a vehicle seat with a sash belt guide that can be configured to different positions both horizontally and vertically, thereby enabling the position of the sash belt to be configured with respect to the occupant;

FIG. 2b shows an older child sitting on a booster seat and restrained with an adult three-point seatbelt, but using the sash belt guide of FIG. 2, so that the sash belt is correctly positioned with respect to the shoulder of the child.

FIG. 3 shows a sash belt guide that engages a head rest and which can be positioned on either side of a head rest at various sideways extensions from the headrest to engage sash belt in a comfortable position with regards to the occupant;

FIG. 4 shows a child occupant sitting on a prior art ‘booster’ seat, itself positioned on the vehicle seat, showing that despite the booster seat raising the occupant so that the occupant's shoulders are at a similar height to the shoulders of a typical adult, since adults are typically much broader across the shoulder than children, the sash section of the seat belt lies uncomfortably too close to the child's neck;

FIG. 5 shows a child occupant sitting on a booster seat, itself positioned on the car seat, showing the booster seat raising the child occupant so that the occupant's shoulders are at a similar height to an adult's shoulders, where the head rest of the booster seat is provided with a sideways adjustable sash strap guide enabling positioning of the sash belt to lie comfortably and safely on the shoulder of the child.

FIG. 6 shows a collapsible child's seat that has a head rest with an adjustable sash guide attached thereto, the collapsible child's seat itself positioned on a car seat; and

FIG. 7 shows an occupant sitting on the collapsible child's seat of FIG. 6, showing how the adjustable sash guide adjusts the shoulder strap of the car seat to the child, so that it passes comfortably and safely across the shoulder of the occupant.

### DESCRIPTION OF EMBODIMENTS

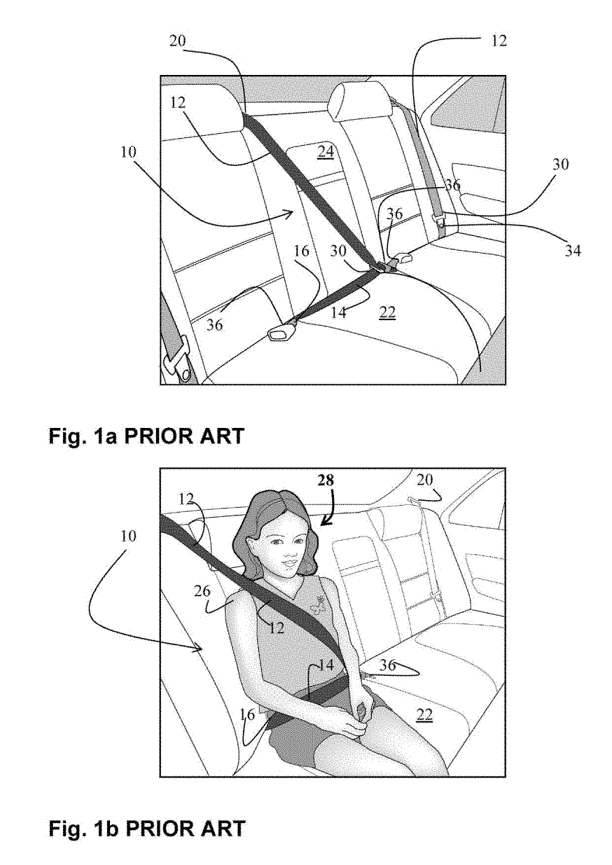

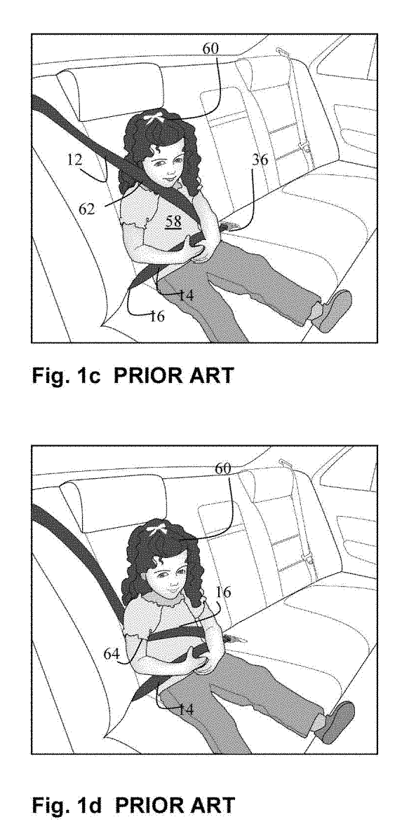

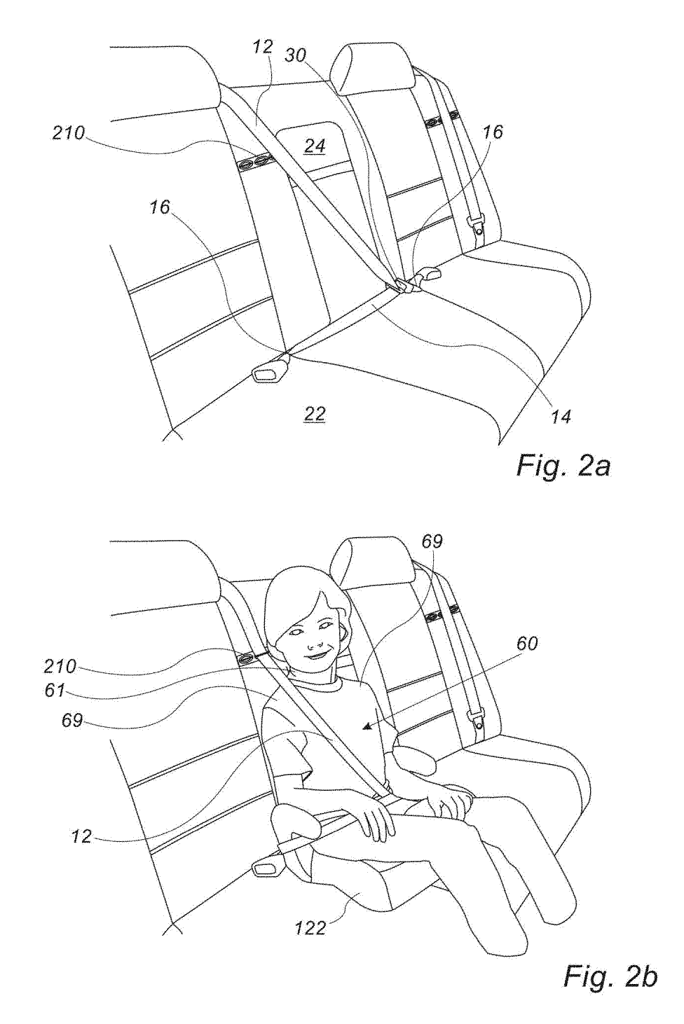

FIG. 1a is a schematic illustration of a typical and ubiquitous prior art seatbelt arrangement designed for adults. With reference to FIG. 1a, the prior art seatbelt arrangement consists of a three point seat belt 10 consisting of a tensioned strap 20 that is typically wound on a tensioned drum 20. The seatbelt 10 is fixed to an anchor point 16, rigidly fixed to the chassis of the vehicle below the seat 22, and a slider 30 with tongue 34 on the three point seat belt 16 is engageable by a clasp 36 that is typically on a strap or arm that positions it, when the seatbelt 10 is worn a few centimeters above the seat 22. The three point seat belt 10 can be considered as being effectively divided into a sash section 12 and a lap section 14 by the slider 30. Such a three point seat belt 10 is designed for use by adult sized passengers.

FIG. 1b is a schematic illustration of an occupant 28 restrained by a prior art seatbelt arrangement 10 of FIG. 1a. With reference to FIG. 1b, since the seat belt 10 is designed for adults sized occupants, the sash section 12 of the seatbelt 10 sits properly on the shoulder 26 of an adult sized occupant 28 in a manner that is both comfortable and safety providing. Similarly, the lap strap section 14 sits over the lap of the occupant and curls around the occupant from the slider in clasp 36 to the anchor point 16, both of which are snug against the adult's hips. Consequently, the seatbelt 10 restrains the adult sized occupant in a comfortable and secure manner.

FIG. 1c is a schematic illustration of a child occupant 60 restrained by the prior art seatbelt arrangement 10, designed for adult use, that is shown in FIGS. 1a and 1b. With reference to FIG. 1c, since the seat belt 10 is designed for adults that are taller and broader than children, the sash section 12 of the seatbelt 10 does not sit properly on the shoulder 62 of the child occupant 60, but, somewhat uncomfortably and dangerously, the sash section of the belt rubs against the child's neck. Furthermore, it will be noted that the child has narrower hips than an adult and so the lap strap 14 is not held down around the child's hip, but the separation between anchor point 16 and slider and clasp 36 is large. In a sudden stopping, the child 50 may slide out under the lap strap 14.

With reference to FIG. 1d which is a further schematic illustration of a child occupant 60 restrained by the prior art seatbelt arrangement 10, designed for adult use, that is shown in FIGS. 1a and 1b, showing that sometimes a child occupant 60 positions the sash section 16 under the armpit 64, and thereby away from the neck. This arrangement is more comfortable for the child 60. Although more comfortable, the positioning of the seatbelt 10 under the armpit 64 as shown in FIG. 1d is not safe. Placing the sash section 12 under the arm is dangerous in that instead of tightening onto the clavicle and ribcage, in a collision, both sash 12 and lap 14 sections of the seatbelt 10 may tighten on the abdomen, of the child below the rib cage on soft tissues only.

FIG. 2a shows a car seat wherein the back of the seat is provided with a sash belt guide 210 that can be configured to different horizontal positions, thereby enabling the position of the sash belt to be configured with respect to the child. In contrast to the approach described in U.S. Pat. No. 6,846,020 to Zhaoxia Xu, the approach described here, provides a plurality of fixing positions at different sideways displacements, rather than vertical displacements. It will, however, be appreciated that different vertical displacements may also be provided.

The sash belt guide 210 may comprise an array of loops or a flat hook or clasp and an array of housings or anchor points for the flat hook or clasp. The sash belt guide 210 typically includes a row of positions going from left to right, enabling sideways adjustment of the sash strap 12, changing the angle that it crosses the occupant.

FIG. 2b shows a child occupant 60 on a booster seat 122 that is on the car seat 22, where the sash strap 12 is sideways configured using the sash belt guide 210 of FIG. 2a. Despite the child 60 being far less broad than an adult, due to the sash belt guide 210, the sash section of the seat belt properly lies across the shoulder 62 of the child occupant 60, providing security and comfort.

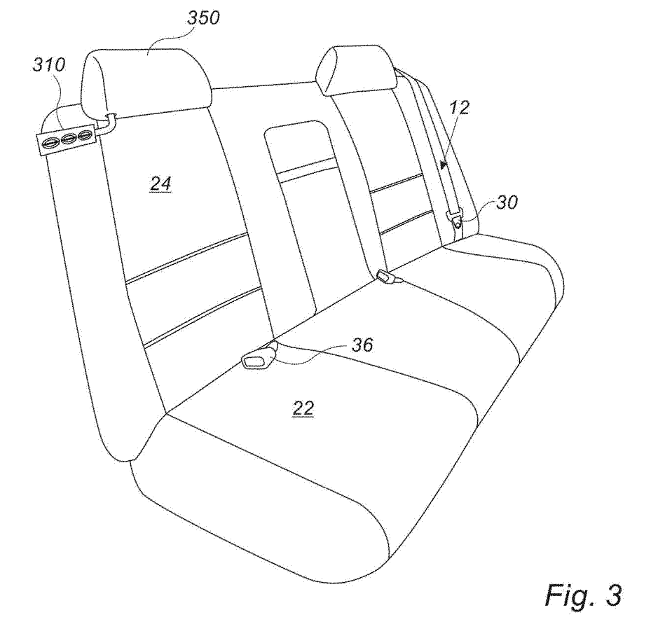

FIG. 3 shows a that is attached to the head rest that is integral to many vehicles, and which can be positioned on either side of a head rest at various sideways extensions from the headrest to engage the sash belt 12 in a comfortable position with regards to the child 60. An advantage of the system of FIG. 3 is that it does not effectively change the back 24 of the vehicle seat 22, and so the seat 22 remains comfortable and appropriate for adults as well as for children. As shown, the sash belt guide 310 is integral to the head rest, but it will be appreciated that in some embodiments, a sash belt guide 310 could be retrofitted to a head rest, perhaps configured to clamp onto the metal posts of the head rest that attach head rests to the back seat, and so some embodiments of this type may be retrofittable to the head rests of existing passenger seats.

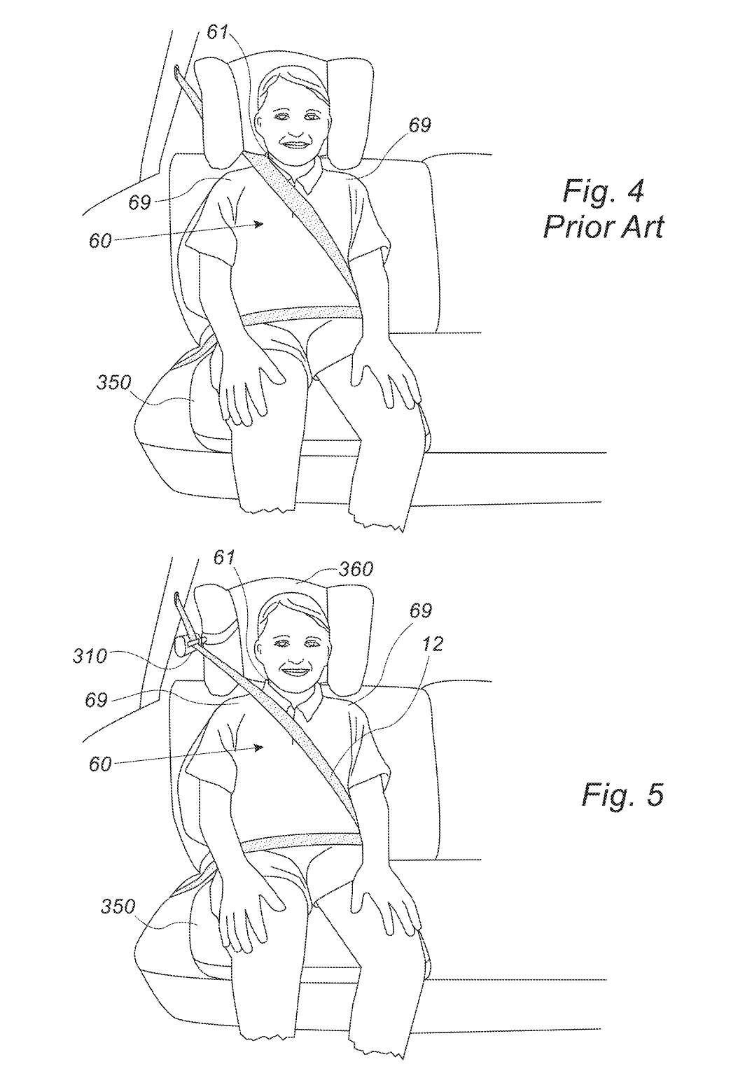

With reference to prior art FIG. 4, there is shown a child 60 sitting on a prior art booster seat 350, itself positioned on a seat 22 of a vehicle. It will be noted, that despite the booster seat 350 raising the child so that the child's shoulders 69 are at a similar height to an adult's shoulders. However, since adults are much broader across the shoulder than children, the sash section of the seat belt 12 often lies too close to the child's neck 61.

Contrasting with prior art arrangement of FIG. 4, FIG. 5 shows a child occupant 60 sitting on a modified booster seat 350 that is itself positioned on the car seat 33, where the head rest 360 of the booster seat 350 is provided with a sideways adjustable sash strap guide 310 enabling positioning of the sash belt 12 to lie comfortably and safely on the shoulder 69 of the child occupant 60, thereby enabling the child occupant 60 to be both comfortably and safely secured.

As described at length in U.S. Pat. No. 9,376,088, traditional booster seats take up space, and when a vehicle provided with such booster seats are required to carry adults, the booster seats fill up the luggage compartment. Consequently, occasional transporters of children, such as grandparents, rarely carry booster seats, and cars fitted with booster seats that are not carrying children will not offer assistance to adults, such as neighbors since there is nowhere to put them. Furthermore, due to such booster seats being childish, older children and shorter adults will be loath to use them.

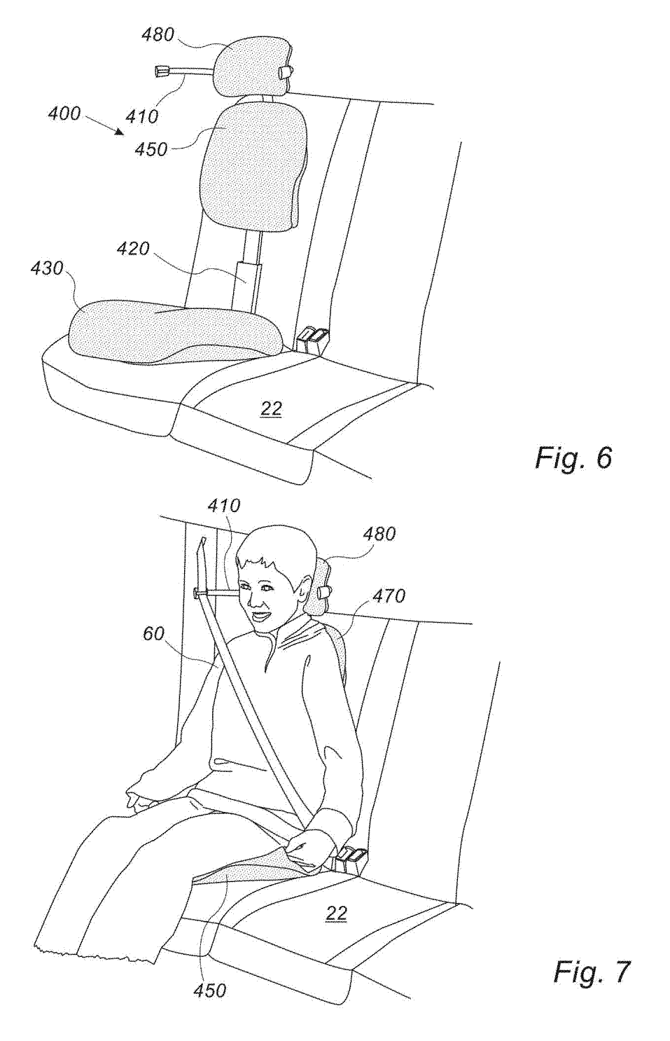

With reference to FIG. 6, a collapsible child's seat 400 that has a head rest 480 with an adjustable sash guide 410 attached thereto, wherein the collapsible child's seat 400 itself being positioned on a car seat 22. The collapsible child's seat 400 has a seat portion 430 that itself may fold, and a head support portion 480 that is connected to the seat portion 410 by a strut 420. The strut 420 may be telescopic and may be hinged at the seat 430 end and/or at the head support 480 end, enabling it to fold and be compacted. A back section 450 may be included, and in some embodiments, the strut slides into and out of the back section allowing compaction. In some embodiments, the collapsible child's seat 400 may have hinged right and left side head supports that restrain the head of the occupant. The back and sides of the head support may be upholstered for comfort. Attached to the head support 480 is an adjustable sash belt guide 410 that is sideways adjustable to engage the sash strap section 12 at different lateral displacements from the axis of the collapsible child's seat 400.

FIG. 7 shows a child sitting on the collapsible child's seat of FIG. 6, showing how the adjustable sash guide adjusts the sash strap section 12 of the vehicle seat to the occupant 60, so that it passes comfortably and safely across the shoulder 69 of the occupant 60.

Possibly by virtue of the support strut being telescopic, and possibly by virtue of the sash strap guide being positionable at different altitudes with respect to the seat back, in some embodiments, the position of the sash strap guide is not only horizontally adjustable but is also vertically adjustable.

Thus there is provided an apparatus for adapting for use by a shorter occupant such as a child, an adult three-point seatbelt of a vehicle of the type consisting of a tensioned belt wound on a drum that extends from above shoulder height of an adult occupant of a seat to an anchor point connected to chassis of vehicle, and a clasp attached to the chassis on opposite side of the occupant of the seat from the anchor point, such that the belt may be drawn downwards and across the occupant to engage the clasp, thereby restraining the occupant with both a sash section and a lap section of the seatbelt. The apparatus consists of a sash section guide for the sash section of the seat belt that is fixed to a seat and sideways adjustable with respect to the occupant sitting on the seat for engaging the sash section above a shoulder of the occupant at a sideways variable position to ensure that the sash section runs over occupant's shoulder in an optimal position for both comfort and safety. The sash section guide may be attached to the vehicle seat itself or to a seat for a child, such as a booster seat, that itself sits under the child, on the vehicle seat.

Thus persons skilled in the art will appreciate that the present invention is not limited to what has been particularly shown and described hereinabove. Rather the scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

1. An apparatus for adapting to an occupant, an adult three-point seatbelt of a vehicle having a chassis, the adult three-point comprising a belt that extends from an upper point proximal to a shoulder of an adult occupant of a seat, to a lower anchor point connected to the chassis below the upper point, and a tongue on a slider attached to said strap, for dividing said strap into a sash section and a lap section, and a buckle attached to the chassis on an opposite side of the occupant of the seat from the lower anchor point, such that the belt may be drawn downwards and diagonally across an occupant to for the tongue to engage the buckle, thereby restraining the occupant with both a diagonal sash section and a lap section of the seatbelt, the apparatus comprising a guide for the sash section of the seat belt that is fixed to a seat and sideways adjustable with respect to the occupant sitting on said seat, said guide for engaging said sash session above a shoulder of said occupant at a sideways position to ensure that said sash section runs over a shoulder of the occupant in an optimal position for both comfort and safety.

2. The apparatus of claim 1 wherein said adult three-point is selected from the group of a tensioned belt wound on a drum and a 3 point static seat belt.

3. The apparatus of claim 1 wherein said seat is a built-in vehicle seat and said guide is coupled to back of said built-in vehicle seat.

4. The apparatus of claim 1 wherein said seat is a built-in car seat and said guide is coupled to a headrest of said built-in vehicle seat.

5. The apparatus of claim 1 wherein said guide is retrofittable to said vehicle seat.

6. The apparatus of claim 1 wherein said seat is a booster seat and said guide is adjustably coupled to said booster seat.

7. The apparatus of claim 5 wherein said seat is a booster seat and said guide is adjustably coupled to said booster seat.

8. The apparatus of claim 5 wherein said seat is a booster seat with a headrest and said guide is adjustably coupled to said head rest.

9. The apparatus of claim 1 wherein said seat is a collapsible child's seat that is positioned on integral vehicle seat under the occupant, and having a guide for engaging the sash strap of the vehicle that is sideways positionable with respect to shoulder of an occupant sitting on said apparatus.

10. The apparatus of claim 8 comprising a seat section, a headrest coupled to the seat section by an adjustable strut, wherein the guide for engaging the strut is sideways adjustably coupled to the head rest.

11. The apparatus of claim 8 wherein said strut is telescopic.

12. The apparatus of claim 8 wherein said strut folds with respect to the said section.

13. The apparatus of claim 8 wherein said strut folds with respect to the headrest.

14. The apparatus of claim 8 wherein the sash strap guide is automatically positioned appropriate to an occupant by positioning the head rest appropriately for said occupant.

15. The apparatus of claim 8, where the sash strap guide is forwards-backwards and or up-down as well as sideways adjustable.

16. A method of adjusting an three point seatbelt comprising a sash section and a lap section, to safely and comfortably engage an occupant sitting in a vehicle, comprising providing a sash strap guide that is sideways adjustable for engaging the sash section of the three point seatbelt at a point proximal to the shoulder of the occupant, that is sideways adjustable to optimally position the seatbelt for comfort and safety.

17. The method of claim 16, wherein the guide is attached to a booster seat that engages the lap section over the occupant's legs.

18. The method of claim 16 comprising
providing a collapsible seat comprising
a seat section;
a headrest;
a widthwise adjustable lap strap engaging means for engaging the lap section of a three point seatbelt against the legs of the occupant;
the sash strap guide being adjustably coupled to the headrest for adjustingly engaging the position of the sash strap to correct align the sash strap with the shoulder of the child for optimum comfort and safety.

19. The method of claim 18, wherein the sash strap guide is automatically positioned as collapsible seat is opened out and adjusted to the occupant.

20. The method of claim 16 wherein the sash strap guide may be moved forwards and backwards and/or up and down in addition to sideways movement for optimum positioning with respect to the occupant.
